(19) United States
(12) Patent Application Publication
(10) Pub. No.: US 2020/0167769 A1
(43) Pub. Date: May 28, 2020

(54) DISTRIBUTED LEDGER SETTLEMENT TRANSACTIONS

(71) Applicant: ITS, Inc., Johnston, IA (US)

(72) Inventor: Scott GREEN, West Des Moines, IA (US)

(21) Appl. No.: 16/201,950

(22) Filed: Nov. 27, 2018

(51) Int. Cl. G06Q 20/38

(52) U.S. Cl. CPC G06Q 20/389; G06Q 20/3825

(57) ABSTRACT

Systems and methods for real-time settlement of an electronic payment transaction using a distributed ledger are provided. In various embodiments, the described techniques can employ settlement tokens to replace legacy interbank settlement transactions denominated in fiat currency against depository accounts or payment cards. As an illustrative example, an initial legacy settlement transaction can be removed from a processing queue and swapped for a distributed ledger transaction that references a smart contract. A node of a distributed network can execute a smart contract that mints a value of a specific settlement token corresponding to the value of the fiat currency in the electronic payment transaction. The settlement tokens can be used as a 1-to-1 proxy (i.e., a representation) of the fiat currency. Additionally, the system and methods can facilitate the redemption of a value of settlement tokens for a corresponding value of fiat currency.

### BACKGROUND

Electronic payments between parties are facilitated through electronic payment networks that provide an electronic means of exchanging money without a physical transfer of currency. For example, when a check, debit card, or credit card is used by a payor entity to purchase an item or to pay for a service from a payee entity, a payment network can facilitate the digital transfer of funds from the payor to the payee. While payment networks can report a debit from the payor's account and a credit to the payee's account for non-cash transactions in real-time, there are certain limitations to such payment networks that inhibit immediate access to credited funds received in this manner. For instance, the reported debit and credit amount is not the actual transfer of the funds from the payor to the payee. Instead, payment networks transfer funds at discrete intervals and in net amounts. In other words, payment networks enable a payee to become aware of a credit to their account, but do not enable the payee to access the credited funds until the funds are formally settled.

### SUMMARY

Traditional fiat currency payment networks are designed to provide real-time authorization and verification of financial transactions, such as cash withdrawals, point-of-sale purchases, bill payments, and fund transfers, by way of example. Although a payment recipient's account and a payment sender's account can appear to be credited and debited in real-time, the actual settlement of funds between the recipient's financial institution and the sender's financial institution is typically completed at discrete intervals (e.g., once a day) in a net amount. During the period between an initial transaction and actual settlement thereof, the recipient is generally unable to access recently-credited funds, due to restrictions mandated by the centralized architecture of traditional settlement processes.

Accordingly, some aspects described herein provide systems and methods that employ aspects of distributed ledger technologies to facilitate bilateral real-time settlement of fiat-based currency payments through settlement tokens exchanged and tracked on a distributed ledger. The disclosed systems and methods can reduce or eliminate the inherent shortcomings of conventional settlement technologies. Unlike conventional technologies, an exchange of settlement tokens utilizing various embodiments described herein can enable the terms of a bilateral agreement to be facilitated in real-time by a settlement token smart contract stored on a distributed ledger such as a blockchain.

This summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

### BRIEF DESCRIPTION OF THE DRAWINGS

Illustrative embodiments of the present invention are described in detail below with reference to the attached drawing figures, and wherein:

FIG. 1 is an exemplary system diagram of a distributed ledger network in accordance with some embodiments of the present invention;

FIG. 2 is an exemplary system diagram of a distributed ledger settlement token network in accordance with some embodiments of the present invention;

FIG. 3 is a block diagram depicting an exemplary payment network server in accordance with some embodiments of the present invention;

FIG. 4 is a block diagram depicting an exemplary financial institution server in accordance with some embodiments of the present invention;

FIG. 5 is a block diagram depicting an exemplary node of a distributed ledger settlement token network in accordance with some embodiments of the present invention;

FIG. 6 is a flow diagram depicting an exemplary method for converting a legacy settlement to a distributed ledger settlement in accordance with some embodiments of the present invention;

FIG. 7 is a flow diagram depicting an exemplary method for distributing settlement token rewards through a distributed ledger settlement token network in accordance with some embodiments of the present invention; and

FIG. 8 is a block diagram of an exemplary computing environment suitable for use in implementing some embodiments of the present invention.

### DETAILED DESCRIPTION

The subject matter of the technology described herein is described with specificity to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and “block” may be used herein to connote different elements of the methods employed, the terms should not be interpreted as implying any particular order among or between various steps herein disclosed unless and except when the order of individual steps is explicitly described.

As used herein, “fiat currency” is used with its commonly understood meaning in the art and refers to legal tender such as, by way of example, United States dollars (USD).

The term “settlement token” is used herein with reference to a digital coin or a digital token that corresponds to a unit of fiat currency.

The term “fiat account” is used herein with reference to a depository account for fiat currency.

The term “holding account” is used herein with reference to a fiat account that is designated to hold fiat currency corresponding to unredeemed settlement tokens.

The term “real-time” is used in a context of near real-time, which is commonly understood in the art, and generally accounts for delays inherent in communication and processing technologies, among other things.

Traditional fiat currency payment networks are a conglomeration of two systems. One of the implications of this conglomeration is a lag between when a payee can see a credit to its account, and when the payee can actually utilize some or all of the fiat currency credited to its account. However, the lag is generally necessary because the traditional networks rely on two distinctive system architectures. The first system is built on a peer-to-peer architecture that provides real-time authorization and verification of electronic financial transactions, such as those initiated by virtue of cash withdrawals, purchases, bill payments, and fund transfers. As a result, a payee's account and a payor's account can be shown with corresponding credits and debits in real-time. However, the actual electronic settlement of funds between the payee's financial institution and the payor's financial institution is typically completed by the second system, which is built on a centralized authority architecture configured to process electronic settlement transactions at discrete intervals (e.g., once a day) in a net amount.

By supplementing or replacing the central authority architecture with a distributed ledger architecture, a payment network can reduce or mitigate this network latency. Accordingly, embodiments described herein provide systems and methods that facilitate real-time settlement of fiat currency payments through the generation, distribution, and auditing of electronic settlement tokens that can reduce or mitigate the costs, technical limitations, and risks of conventional (“legacy”) settlement technologies. In some embodiments, a financial entity can employ a computing device to generate a real-time settlement agreement having terms specified via a settlement token smart contract (“STSC”) stored in a distributed ledger, such as a blockchain. Further, in some aspects, the STSC can include specified terms for the use, reward, redemption, and destruction of the settlement tokens generated by the STSC. As an alternative to conventional payment networks that necessitate periodic lags, the STSC can be employed to generate fungible, transferrable, and redeemable electronic settlement tokens in real-time, without the constraint of periodic lags. In this way, a payee can employ a computing device to quickly access these electronic settlement tokens for subsequent purchases or redemption to fiat currency.

In some aspects, financial institutions participating in various embodiments of the disclosed system can employ computing devices to store generated settlement token smart contracts onto a distributed ledger. A settlement token smart contract can be employed to generate settlement tokens, which can be backed 1:1 by fiat currency determined to be held on deposit by the financial institution's computing device. In some aspects, the settlement tokens can be accessed by a computing device associated with a payee and subsequently transferred while remaining traceable via the smart contract. Thus, the settlement token can be redeemed by any party's computing device controlling a wallet containing the settlement tokens (e.g., the original payee or any other subsequent entity controlling the settlement token) for fiat currency in a holding account maintained or monitored by the financial institution's computing device. Additionally, some aspects of the described embodiments can facilitate real-time settlement without requiring the payor's ownership (e.g., possession or control) of settlement tokens.

For example, a transaction request is received by a payment-network server from a payee's (hereinafter also referenced as a “payment requestor”) computing device. The transaction can include, among other things, a unique payor identifier, a unique requestor identifier associated with the payment requestor, a payment amount, and a smart contract address. The smart contract address corresponds to a smart contract stored in a distributed ledger, and can be triggered to generate a particular number of settlement tokens (hereinafter also referenced as a “token value”) corresponding to the payment amount. The smart contract can be triggered to generate the settlement tokens in response to a determination that the distributed ledger includes the transaction request, whereby the transaction request includes a digital signature or is digitally signed with keys associated with the payment requestor and a financial entity of the payor. The transaction request can correspond to a legacy transaction (e.g., a conventional settlement transaction) that is held in a queue for batch processing by the payment-network server via a central authority. The payment-network server identifies the transaction and removes it from the batch settlement queue. The settlement is then facilitated real-time through a settlement token transaction via the distributed ledger. Thus, legacy settlement via a central authority is swapped for settlement via a distributed ledger. The payment requestor's computing device can then access the settlement tokens as a fiat currency proxy (e.g., a representation of fiat currency), hold the settlement tokens for later use, or redeem the settlement tokens for fiat currency according to the terms of the smart contract.

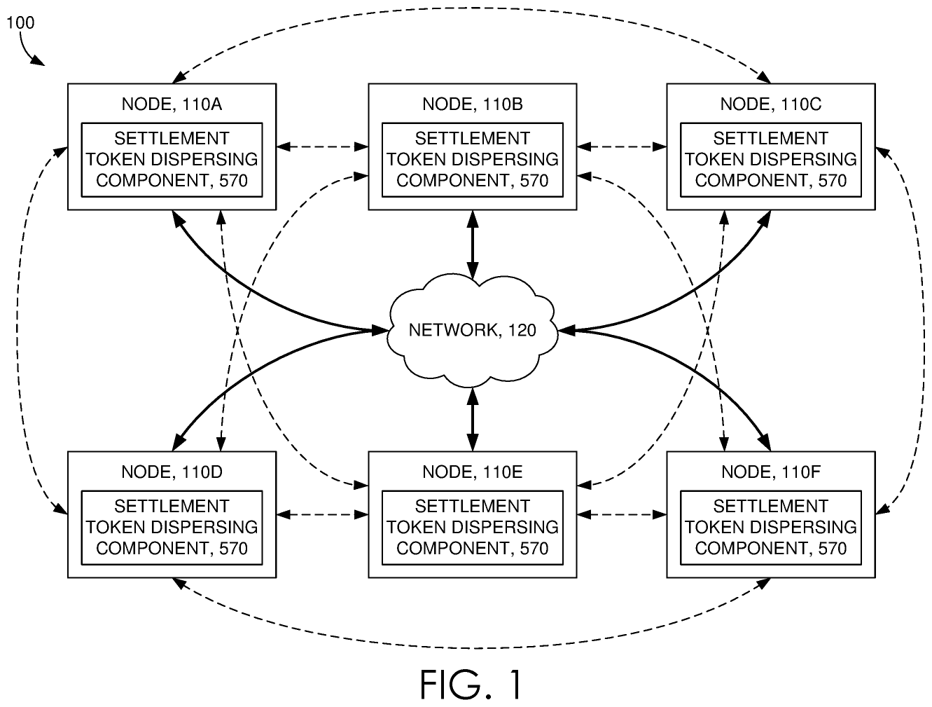

Turning now to FIG. 1, a schematic depiction is provided illustrating an exemplary distributed ledger network 100 in which some embodiments of the present invention can be employed. It should be understood that this and other arrangements described herein are set forth only as examples. Other arrangements and elements (e.g., machines, interfaces, functions, orders, groupings of functions, etc.) can be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by one or more entities may be carried out by hardware, firmware, and software. For instance, various functions may be carried out by a processor executing instructions stored in memory.

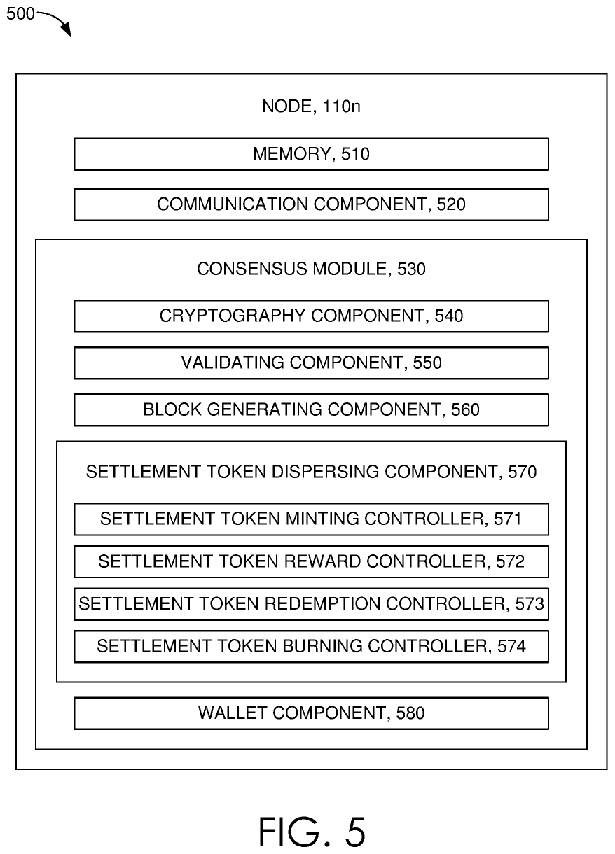

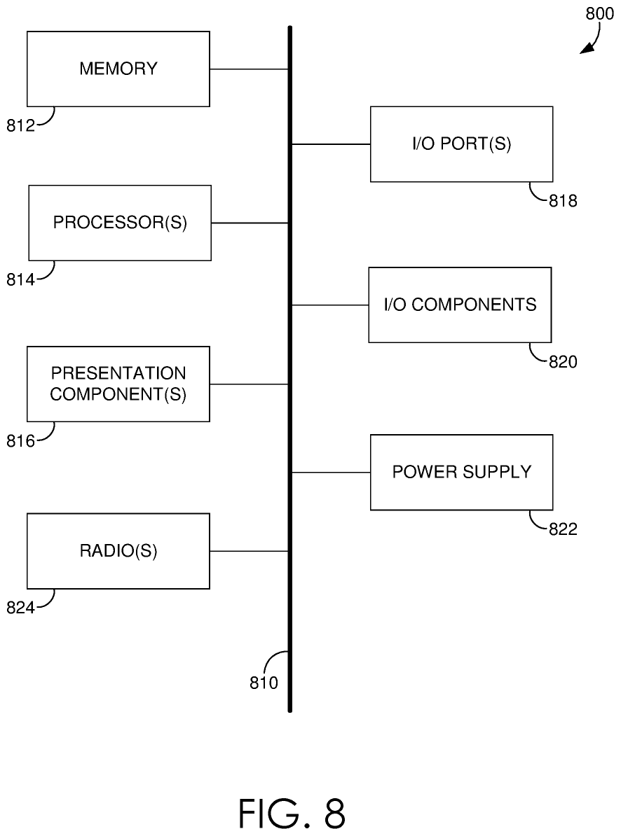

The distributed ledger network 100 depicted in FIG. 1 includes a plurality of nodes 110A-110F that are each in communication with one or more nodes 110A-110F over a network, such as the Internet. In accordance with the present disclosure, each node 110A-110F is a node of a distributed ledger network, which is also a computing device later described in accordance with FIG. 8. In some embodiments, one or more nodes 110A-110F include a settlement token dispersing component, such as settlement token dispersing component 570. The settlement token dispersing component 570 can execute functions or operation defined in a STSC as described in more detail below and in reference to FIG. 5. Generally, the settlement token dispersing component 570 can enable a node to generate new settlement tokens (“mint”), destroy (“burn”) settlement tokens, reward a wallet address holding settlement tokens, and facilitate the redemption of settlement tokens for fiat currency based on terms of the particular STSC governing the settlement tokens included in a transaction received by the node.

In some embodiments, and preferably for public blockchain implementations, each node 110A-110F in the distributed ledger network 100 can operate as a peer to every other node 110A-110F of the distributed ledger network 110, such that no single node 110A-110F is more influential or powerful than any other node 110A-110F. Operations performed by nodes can include, among other things, validating transactions, verifying blocks of transactions, and adding records to an immutable database that is collectively maintained by the nodes 110A-110F. It is contemplated, however, that in some embodiments, a particular subset of the nodes 110A-110F can be specifically designated for performing a subset of or all node operations described herein. In this regard, as opposed to embodiments where each node is a peer with other nodes, some embodiments can employ specially designated nodes (preferably for private blockchains or ecosystems where centralization is not a concern) that perform a subset of or all of the described node operations.

In accordance with embodiments described herein, the immutable database collectively maintained by the nodes 110A-110F is referenced herein as a blockchain. The blockchain maintained by the distributed ledger network 100 includes a plurality of records that is immutable by virtue of the distributed nature of the distributed ledger network 100, applied cryptography concepts, and a consensus module that is independently included and operated by any number of nodes 110A-110F. While any node can generate a transaction to be added to the blockchain, the consensus module requires that the record be added to the blockchain only based on a determination that a consensus (e.g., greater than 50%) of the nodes 110A-110F (or designated nodes) has collectively validated the transaction. In this regard, while each node 110A-110F can independently store a copy of the blockchain, a record can only be added to the blockchain when a consensus to add the record has been reached by the nodes 110A-110F (or designated nodes) of the distributed ledger network 100.

In various embodiments, validation of a transaction is facilitated utilizing features of asymmetric key cryptography (i.e., public-private key pairs), among other things. In some aspects, as is commonly known in public blockchains (e.g., Bitcoin), a private key can be employed to generate one or more associated public keys, encrypt data that can only be decrypted by an associated public key, and digitally sign data or transactions. On the other hand, a public key can be employed to decrypt data encrypted by an associated private key, encrypt data that only the private key can decrypt, and digitally authenticate a digital signature generated by an associated private key. As public keys can be shared freely, public keys generally function as “wallet addresses” that are associated with a private key. In this regard, digital tokens or other units of value (e.g., Bitcoin) can be “transmitted” from one wallet address (i.e., a public key of a sender) to another wallet address (i.e., a public key of a receiver). In actuality, however, the transmission of a digital token or unit of value is not a physical transfer, but is represented as a record of transfer from one wallet address to another that, if validated, is recorded onto the blockchain. The record is not finalized (i.e., added to the blockchain), however, until the transfer is validated by a consensus of the nodes 110A-110F in the distributed ledger network 100.

To generate a transaction to transfer a digital token(s) or value, the owner of the sending wallet address can digitally sign the transaction with the private key associated with the sending wallet address. Nodes 110A-110F (or designated nodes) of the distributed ledger network 100 must independently determine that the transaction from the sending wallet address is valid by digitally authenticating the digital signature with the sending wallet address (i.e., the public key). The nodes 110A-110F (or designated nodes) must also independently determine, by referencing their independently stored copy of the blockchain, that the sending wallet address is in fact associated with the digital token being transferred, or that the sending wallet address has sufficient liquidity (i.e., has a calculated aggregate value based on associated records in a local copy of the blockchain) to transfer the unit(s) of value. If a node (or designated node) in the distributed ledger network 100 determines that either of the foregoing conditions is not satisfied, the transaction is determined invalid by the node and the transaction is not passed on (e.g., communicated) to other nodes (or designated nodes) to which it is connected. On the other hand, if the node (or designated node) determines that both of the foregoing conditions are satisfied, the transaction is determined valid and the node passes on (e.g., communicates) the transaction, along with an indication that the node independently validated the transaction, to other nodes 110A-110F (or designated nodes) to which it is connected. As the nodes 110A-110F in the distributed ledger network 100 are all directly or indirectly connected to one another, this validation process continues until the nodes (or designated nodes) collectively determine that a majority (i.e., consensus) has validated the transaction. The collective determination of consensus can be facilitated by virtue of each node (or designated node) maintaining a list of other nodes (or designated nodes) on the network (e.g., by I.P. address or other identifier) along with their respective determinations of transaction validity.

After a consensus of validity for a transaction has been reached by the nodes 110A-110F (or designated nodes), the transaction awaits confirmation (i.e., addition to the blockchain). As the nodes 110A-110F (or designated nodes) can be peers with each other, any node (or designated node) can participate in the process of adding the transaction to the blockchain. For purposes of background, the blockchain includes records of validated transactions that are grouped into a cryptographically chained series of blocks, whereby each block includes a subset of these records. Any node 110A-110F (or designated node) can perform the process of block generation, which can be implemented in a variety of ways based on a consensus algorithm implemented within its consensus module including, but not limited to, proof of work, proof of stake, proof of authority, practical Byzantine Fault Tolerance, or Federated Byzantine Agreements. As the aforementioned processes for block generation are generally known in the art, additional detail for these processes are not described herein. It is contemplated, however, that any implementation of block generation and consensus determination can be employed in accordance with the present disclosure. More importantly, as the general outcome of block generation is relatively similar among these implementations, the following description is provided irrespective of the block generation aspect of the consensus module.

To add a validated transaction to the blockchain, the transaction must first be included into a block that is being generated by one of the nodes 110A-110F (or designated nodes) and subsequently validated by a consensus of the nodes (or designated nodes) in the distributed ledger network 100. The transaction can be independently included into a block, or grouped together with other transactions, either of which are included within the purview of the present disclosure. Such implementations may vary, however, based on consensus module design and a block size (i.e., memory limitation) implemented or defined within the consensus module operated by the nodes 110A-110F (or designated nodes). The node generating the block must also include, into the block it is generating, a cryptographic hash of the block most recently added to the blockchain. Once generated in accordance with consensus rules defined within the consensus module, the node generating the block can send the generated block to the nodes (or designated nodes) to which it is connected.

The nodes (or designated nodes) receiving the generated block can then verify that the block includes one or more valid transactions, includes a hash value of the block most recently added to the blockchain, and was generated in accordance with the defined consensus rules. Upon verifying the foregoing, the nodes (or designated nodes) can pass on (e.g., communicate) the verified block to its neighboring nodes (or neighboring designated nodes). In this way, similar to how a transaction is validated by a determined consensus of the distributed ledger network 100, the generated block including at least the transaction can be verified by another determined consensus of the nodes (or designated nodes). When a determination is made by a consensus of the nodes 110A-110F (or designated nodes) that a block is verified, the newly verified block is added to the blockchain immediately subsequent to the previously added block, the hash of the previously added block being included in the newly verified block. As such, each block is cryptographically “chained” to a previous block and a subsequent block. In other words, the cryptographic hashes facilitate maintenance of the order and accuracy of records included in the blockchain.

With specific regard to STSCs stored as records on the blockchain, a STSC can include any algorithm that defines an action or event that is to be triggered based on a determination that one or more defined conditions precedent to the action or event have occurred. In various embodiments, a STSC can be generated, transmitted, received, stored, validated, and verified by any node or computing device described in accordance with the present disclosure. For example, a financial institution server, such as financial institution server 250, can generate a settlement token smart contract and communicate it to a node. It is further contemplated that a consensus module of each node or computing device in the distributed ledger network 100 is capable of interpreting and executing a Turing complete programming language, such as Solidity, by way of non-limiting example. It is further contemplated that in some embodiments, the blockchain itself is implemented based on the same programming language. The smart contract can include programming language that performs various functions such as, but not limited to, minting settlement tokens, burning settlement tokens, redeeming settlement tokens, and rewarding holders of settlement tokens, as illustratively provided in pseudocode below. It will be understood in the art that these examples are merely illustrative and the form, terms, and code will vary widely and can include more or less terms or code based on the programming language used, the specific embodiment, and many other factors commonly understood in the art.

Mint settlementtoken {

if transactionref has{mycreatorsig, requestorsig, requestoraddress,

transactionamount}

then{

check currenttime
add(settlementtoken, amount(transactionamount), set

minttime(currenttime)) to requestoraddress}
end}

Burn settlementtoken{

if tranasctionref has{requestoraddress, requestorsig, confirmburn,
burnamount}
then{substract(settlementoken, amount(burnamount)) from
requestoraddress}
end}

Redeem settlementtoken{

if transactionref has{requestoraddress, requestorsig, mycreatorsig,

redeemamount}

then{

subtract(settlementtoken, amount(redeemamount)) from
requestoraddress
add(settlementtoken, amount(redeemamount), set
redeemstatus(1)) to

mycreatoraddress

}

end}

Reward settlemetntoken{

if transactionref has{requestoraddress, requestorsig, rewardrequest}
then{

check settlementtokens of requestoraddress
check currenttime
set rewardcount = 0
each settlementtoken of settlementtokens{

check prevrewardtime
check redeemstatus
if {diff(currenttime, prevrewardtime) ≥ rewardtime, and
redeemstatus(0)}
then{

rewardcount + 1 = rewardcount
set prevrewardtime(currenttime)}

}

add(settlementtoken, amount(rewardcount x reward)) to
requestoraddress

}

end}

In various embodiments, STSCs stored on the blockchain can be associated with a corresponding address, similar to that of a wallet address. The smart contract can be assigned a corresponding address by the distributed ledger network 100, or can be associated with a wallet address associated with one or more private keys. Counterparties associated with a STSC can verify, via their respective computing devices in communication with one or more nodes of the distributed ledger network 100, that the STSC has been immutably stored onto the blockchain based on a determined consensus of the nodes 110A-110F.

As STSCs can be stored on the blockchain, each node (or designated node) can independently determine whether a STSCs defined conditions precedent have occurred in order to verify that the terms of the STSC have been met. In various embodiments, each node (or designated node) can determine the occurrence of defined conditions precedent based on electronic information communicated thereto or retrieved thereby. The electronic information can include, among other things, another transaction addressed to, or referencing, the STSC, data from one or more computing devices remote from the distributed ledger network 100, data from a website, data from a database, or any other type of electronic information that can be transmitted to or accessed by a node (or designated node) via the network 120.

Like other transactions, each node (or designated node) can communicate this verification to one or more neighboring nodes (e.g., other nodes in direct communication with the node or designated node) until a consensus of the nodes 110A-110F (or designated nodes) of the distributed ledger network 100 have collectively verified occurrence of the defined conditions precedent. Based on a determination that the defined conditions precedent has been verified by a consensus of the nodes 110A-110F, the event or action defined by the STSC can be executed. In various embodiments, the event or action can include the processing of a transaction (e.g., a processing of a transfer of settlement tokens) that is held or locked until a determination that the conditions precedent have occurred. In this regard, a settlement token that is subject to the STSC can be locked (e.g., held in escrow) by the STSC until the determination has been made.

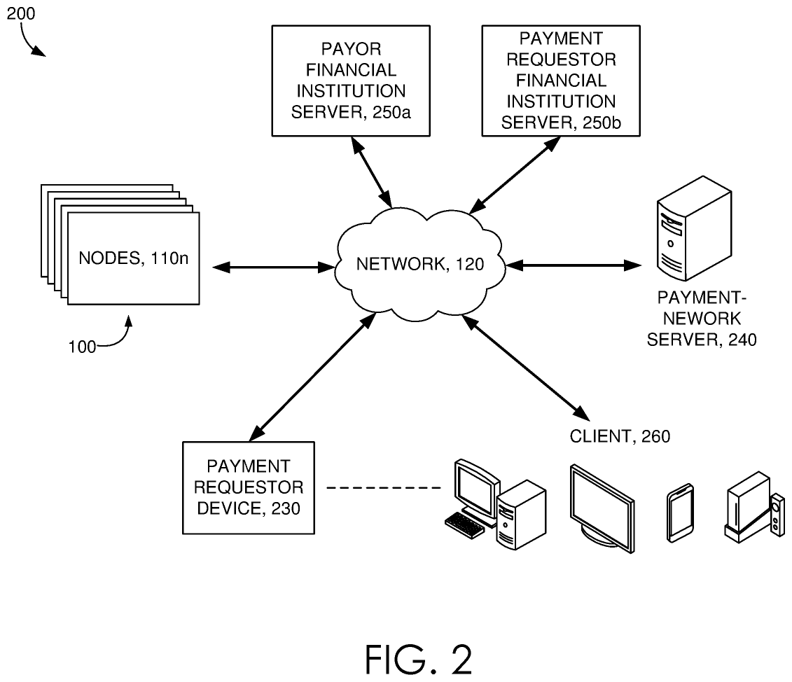

Referring now to FIG. 2, a schematic depiction is provided illustrating an exemplary system 200 in which some embodiments of the present invention can be employed. It should be understood that this and other arrangements described herein are set forth only as examples. Other arrangements and elements (e.g., machines, interfaces, functions, orders, groupings of functions, etc.) can be used in addition to or instead of those shown, and some elements can be omitted altogether. Further, many of the elements described herein are functional entities that can be implemented as discrete or distributed components or in conjunction with other components, and in any suitable combination and location. Various functions described herein as being performed by one or more entities can be carried out by hardware, firmware, and software. For instance, various functions can be carried out by a processor executing instructions stored in memory.

The system 200 can include, among other things, a distributed ledger network 100 comprising a plurality of nodes 110n as described with reference to FIG. 1, each in direct or indirect communication with one another via a network 120. It is contemplated that the nodes 110n can include a subset of designated nodes authorized to perform specifically designated operations, such as validation, verification, or block generation, among other things. The system 200 can also include one or more payment requestor devices (PRDs), such as payment request device 230. It is contemplated that any one or more nodes 110n can be a PRD, such as PRD 230. In this regard, nodes 110n and PRD 230 are computing devices also described herein in accordance with FIG. 8. In some embodiments, PRD 230 can be a point-of-sale device (such as a register, debit/credit card reader, check reader, and so forth), a server hosting an online retailer, or any other computing device capable of, at least, facilitating non-cash transactions.

In one aspect, a PRD 230 can include the consensus module similarly included in other nodes 110n (or designated nodes) within the distributed ledger network 100. In another aspect, the PRD 230 can generate transactions that can initially be validated locally, via the consensus module included therein, before the transaction is passed on to other nodes. In another aspect, a PRD 230 can be in communication with one or more nodes 110n via the network 120, and can locally generate a transaction for communication via the network 120 to one or more nodes 110n that the PRD 230 is in communication with. In this way, the one or more nodes 110n (or designated nodes) receiving the transaction directly or indirectly from the PRD 230 can validate the transaction in accordance with the present disclosure. In some aspects, the PRD 230 can be a designated node(s).

In some aspects, any node 110n can operate as a node that includes the consensus module, and any PRD 230 can operate as a PRD device that can: transmit communications to one or more nodes 110n, generate transactions, and receive communications (e.g., transaction status, blockchain data) from one or more nodes 110n. For purposes of simplicity, the following description will reference a PRD 230 as a node 110n, though embodiments are not limited as such.

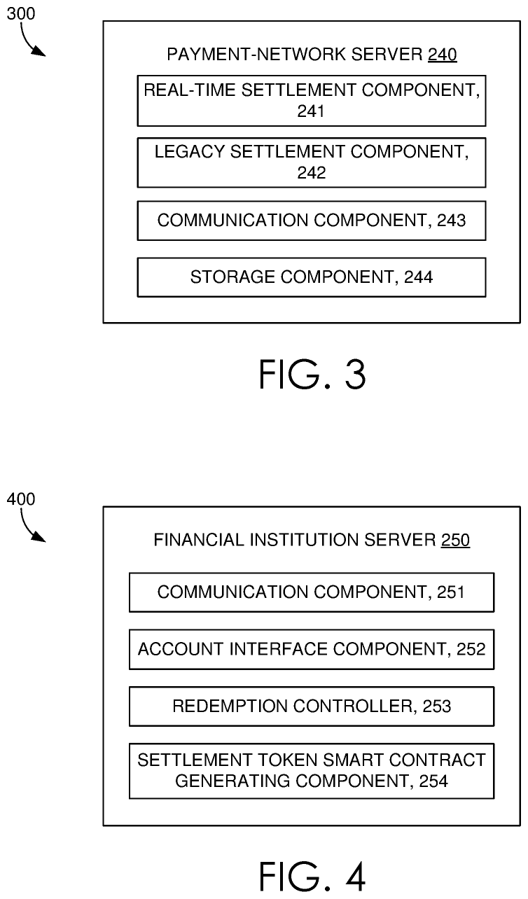

In some embodiments, the system 200 can further include one or more payment-network server (PNS) devices, such as payment-network server 240. The PNS 240 can be in communication with one or more nodes 110n to send generated transactions to the one or more nodes 110n, request and receive transaction status information from the one or more nodes 110n, and request and receive blockchain data from the one or more nodes 110n, among other things. In some further embodiments, PNS 240 can include one or more computing devices, also described in accordance with FIGS. 3 and 4, whereby the one or more computing devices include a consensus module to operate as a node 110n (or designated node). Among other things, the PNS 240 can further provide one or more services, such as data storage services, web hosting services for one or more websites, user authentication services, certificate authentication services, backup services, data mining services, cloud-stored data or web search services, block explorer services, analytics services, and the like, including any combination thereof. In some aspects, the PNS 240 can be a designated node. In some embodiments, PNS 240 can communicate with PRD 230.

In some embodiments, the system 200 can further include one or more financial institution servers (FIS) 250, such as payor's depository FIS 250a and payment requestor's depository FIS 250b. It will be understood that payor's depository FIS 250a and payment requestor's depository FIS 250b can be the same FIS—for illustrative example, where payor and payment requestor have accounts in the same depository financial institution. The FIS 250 stores and is in direct or indirect communication with one or more depository account databases, credit account databases, and other databases storing data corresponding to the assets, such as fiat currency held by people, companies, or entities with accounts at the financial institution. The FIS 250 is in communication with a PNS, such as PNS 240, through network 120. In some aspects, the financial institution controlling an FIS 250 can sponsor participation of FISs not directly participating with system 200. Additionally, in various embodiments, FIS 250 can generate, transmit, receive, store, validate, and verify smart contracts, such as STSCs. The FIS generated STSC can include rules that govern properties of the settlement token generated by the STSC and conditions precedent. By way of non-limiting example, the STSC can be programmed by the FIS 250 to include: a smart contract unique identifier; a token class unique identifier; a token class description, for example a descriptive name; a token creator descriptive name, for example the name of the financial institution controlling the FIS 250; token creator routing number, for example the ABA routing number of the financial institution controlling the FIS 250; a token creator public key; a settlement token address; a settlement token offer period, for example an offer opening date and an offer close date; a set of eligibility rules, for example availability to any taker (any address on the blockchain) or a specific taker(s) (a specific set of addresses on the blockchain); a settlement token smart contract incentive, for example a rate of reward per settlement token owned, a mining reward, and/or an expiration period for the reward; a maturation period, for example the number of days, hours, and/or minutes before fiat currency redemption is available; and an approved oracle. The STSC can be generated in a Turing complete programming language, such as Solidity, by way of non-limiting example.

The system 200 can also include one or more client devices, such as client 260. It is contemplated that any one or more nodes 110n can be a client 260, and one or more clients 260 can be a node in accordance with embodiments described herein. In this regard, nodes 110n and clients 260 are computing devices also described herein in accordance with FIG. 8. In an aspect, at least one client device 260 can be associated with at least one PRD 230. For example, a client device can be accessed by an entity that controls one, more than one, or a plurality of PRDs. Further, client device 260 can be in communication with one or more PRDs, such as one or more PRDs 230. In one aspect, a client 260 can include the consensus module similarly included in other nodes 110n (or designated nodes) within the distributed ledger network 100. In another aspect, the client device 260 can generate transactions that can initially be validated locally, via the consensus module included therein, before the transaction is passed on to other nodes. In another aspect, a client 260 can be in communication with one or more nodes 110n via the network 120, and can locally generate a transaction for communication via the network 120 to one or more nodes 110n that the client device 260 is in communication with. In this way, the one or more nodes 110n (or designated nodes) receiving the transaction directly or indirectly from the client device 260 can validate the transaction in accordance with the present disclosure. In some aspects, any node 110n can operate as a node that includes the consensus module, and any client device 260 can operate as a client device that can: transmit communications to one or more nodes 110n, generate transactions, and receive communications (e.g., transaction status, blockchain data) from one or more nodes 110n. For purposes of simplicity, the following description will reference a client device 260 as a node 110n, though embodiments are not limited as such.

With regard to FIG. 3, a block diagram 300 is provided depicting exemplary components of a PNS 240 in accordance with the present disclosure. Generally, PNS 240 manages the automatic or partially automatic conversion of legacy settlement processes to a distributed ledger settlement. PNS 240 comprises a real-time settlement component 241, a legacy settlement component 242, a communication component 243, and a storage component 244. As discussed above, some embodiments of PNS 240 further comprise a node 110n (or designated node).

The real-time settlement component 241 generally enables the PNS 240 to determine whether received legacy settlement transactions are eligible for distributed ledger (e.g., blockchain) settlement. In an embodiment, real-time settlement component 241 searches the distributed ledger for settlement token smart contracts including at least one of a token creator public key, token creator descriptive name, token creator routing number, and smart contract unique identifier associated with the financial institution(s) servers, such as FIS 250, party to the legacy settlement transaction. In some embodiments, the real-time settlement component 241 queries a directory database stored in storage component 244, which includes unique financial institution identifiers (such as IINs and ABA routing numbers) and STSC addresses associated with the unique financial institution server identifiers, and settlement token data corresponding to each STSC. In some embodiments, the real-time settlement component 241 communicates settlement token smart contract addresses and information to PRD 230 corresponding to the financial institution servers involved in the legacy settlement transaction.

The legacy settlement component 242 generally enables the PNS 240 to parse received legacy settlement transactions to identify financial institutions associated with the transactions. For a non-limiting illustrative example, the legacy settlement component 242 can parse a received transaction to identify a card issue identification number (IIN) per International Organization for Standardization (ISO) 7812 as of the 2017 revision and an ABA routing number. Further, in some aspects, the legacy settlement component 242 communicates, directly or indirectly, the identity of the financial institution server(s) to real-time settlement component 241. Additionally, the legacy settlement component 242 can store, delete, or modify legacy transactions in storage component 244. In some embodiments, legacy settlement component 242 can process legacy settlement transactions, directly or indirectly, through traditional central authority settlement activities in a batch or individually. The legacy settlement component 242 can include a processing queue that includes legacy settlement transactions that have been received but have not been finally settled by the central authority. For example, the legacy settlement component 242 can add received legacy settlement transactions to a processing queue that includes a pool of some or all of the legacy transactions pending batch finalization. For the sake of clarity, the central authority processes are not described or depicted herein because they will be understood by those skilled in the art.

The communication component 243 can include any type of communications device that enables the PNS 240 to communicate with nodes 110n, financial institution servers 250 and other PNSs 240, such as those described in accordance with FIG. 2. Communications can be facilitated utilizing wired or wireless communications, and can employ any short or long-range communications technology including, but not limited to, LANs, WANs, Ethernet, the Internet, WiFi, Bluetooth, NFC, optics (e.g., QR codes, Infrared), Zigbee, radio, RFIDs, and the like. Additionally, communication component 243 can send, receive, and route communications to other components of the PNS 240. In some aspects, the communications component enables the PNS 240 to communicate, directly or indirectly, with legacy settlement networks that process traditional settlement activities, such as via a central authority. For the sake of clarity, the central authority processes are not described herein because they will be understood by those skilled in the art.

The storage component 244 can comprise computer-readable and writable storage media. The storage component generally stores database and records associated with legacy settlement transactions and real-time settlement transactions. For example, the storage component can store one or more reference databases that associate financial institutions, financial institution server devices, settlement token smart contracts and associated distributed ledger addresses, ABA routing numbers, and distributed ledger addresses associated with the financial institution severs.

Turning to FIG. 4, a block diagram 400 is provided depicting example components of a FIS 250 in accordance with the present disclosure. Generally, FIS 250 manages the creation of STSCs and the redemption of settlement tokens. In some embodiments, the FIS 250 can include a communication component 251, an account interface component 252, a redemption controller 253, and a STSC generating component 254. The communication component 251 can include any type of communications device that enables the FIS 250 to communicate with nodes 110n, PNS 240, and other FIS 250, such as those described in accordance with FIG. 2. Communications can be facilitated utilizing wired or wireless communications, and can employ any short or long-range communications technology including, but not limited to, LANs, WANs, Ethernet, the Internet, WiFi, Bluetooth, NFC, optics (e.g., QR codes, Infrared), Zigbee, radio, RFIDs, and the like. Additionally, communication component 251 can send, receive, and route communications to other components of the FIS 250. In some aspects, the communications component enables the FIS 250 to communicate, directly or indirectly, with legacy settlement networks that process traditional settlement activities, such as via a central authority.

In some embodiments, the FIS 250 can include a redemption controller 253. Generally, the redemption controller 253 monitors at least one locally maintained distributed ledger, such as the distributed ledger maintained by node 110n, and activates the account interface component 252 in response to detecting a redemption transaction in the distributed ledger. For example, redemption controller 253 can identify a redemption transaction stored by node 110n that references a STSC associated with the FIS 250 in the distributed ledger and communicate transaction to the account interface component 252. Additionally, or alternatively, in some embodiments the redemption controller 253 receives redemption transaction data from the PNS 240 and communicates the transaction to the account interface component 252.

In some embodiments, the FIS 250 can include an account interface component 252. Generally, the account interface component 252 identifies fiat accounts corresponding to real-time settlement transactions. For a non-limiting example, the account interface component 252 can parse a transaction to identify an account and credit or debit an amount of fiat currency in a fiat account corresponding to the real-time settlement transaction. Further, the account interface component 252 can credit or debit an amount of fiat currency to a holding account corresponding to the debit or credit of the fiat currency account. Said differently, the account interface component 252 can access (or otherwise send, modify, or request) the payor's fiat account identified in the real-time settlement transaction, debit the payor's fiat account, and credit a real-time settlement holding account of the FIS 250. Additionally, the account interface component 252 can access (or otherwise send, modify, or request) the real-time settlement holding account of the FIS 250 associated with a STSC redemption transaction (e.g. the holding account of the financial institution server that created the STSC), debit the real-time settlement holding account, and credit the redemption requestor's fiat account. In some embodiments, crediting the requestor's fiat account can include transferring the credited amount of fiat currency from the real-time settlement holding account to a requestor's fiat account maintained by a financial institution other than the financial institution controlling the FIS 250.

In some embodiments, the FIS 250 includes a STSC generating component 254. Generally, the STSC generating component 254 enables the financial institution controlling the FIS 250 to create STSCs and communicate the created STSCs to a node of the distributed ledger. Additionally, or alternatively, the STSC generating component 254 can communicate the created STSCs to PNS 240. As discussed above, in relation to FIG. 1, the STSC created by STSC generating component 254 can include any algorithm that defines an action or event that is to be triggered based on a determination that one or more defined conditions precedent to the action or event have occurred. For example, the STSC generating component 254 can enable the financial institution controlling the FIS 250 to define an algorithm for minting settlement tokens, burning settlement tokens, redeeming settlement tokens, calculating rewards for settlement tokens, or any combination thereof. Further, the STSC generating component 254 can enable the financial institution to define an approved oracle for the STSC. For example, the STSC generating component 254 can provide a graphical user interface (GUI) to the financial institution, via a directly or indirectly connected computing device. The GUI can provide menus, dialog interactions, and text fields to enable a user to program: a smart contract unique identifier; a token class description, for example a descriptive name; a token creator descriptive name, for example the name of the financial institution controlling the FIS; token creator routing number, for example the ABA routing number of the financial institution controlling the FIS; a token creator public key; a settlement token address; a settlement token offer period, for example an offer opening date and an offer close date; a set of eligibility rules, for example availability to any taker (any address on the blockchain) and a specific taker(s) (a specific set of addresses on the blockchain); a settlement token smart contract incentive, for example a rate of reward per settlement token owned and an expiration period for the reward; a maturation period, for example the number of days, hours, and minutes before fiat currency redemption is available; and an approved oracle.

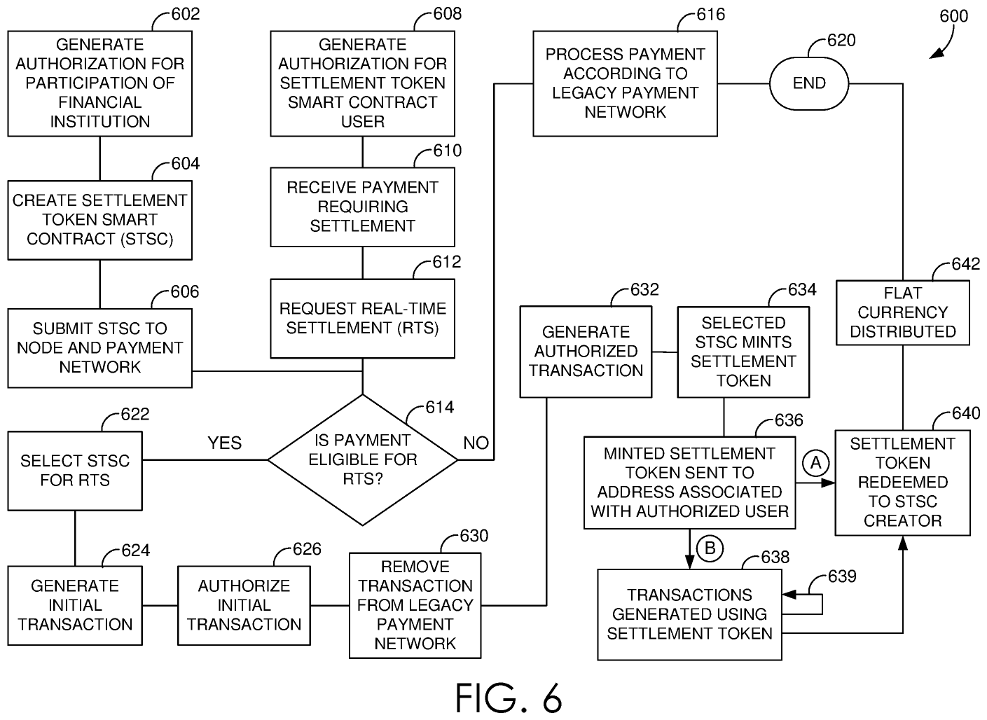

Turning to FIG. 5, a block diagram 500 is provided depicting an exemplary node 150n of a distributed ledger network, such as distributed ledger network 100 of FIG. 1, in accordance with some embodiments of the present disclosure. The node 110n depicted in FIG. 6 can include, among other things, a memory 510 for storing received transactions and the distributed ledger, a communications component 520 for communicating with other nodes or one or more computing devices (e.g., client device 260, PRD 230, FIS 250, and PNS 240 of FIG. 2), and a consensus module 530 for verifying transactions and verifying the distributed ledger with other nodes 110n of the distributed ledger network 100.

The consensus module 530 can include any number of components or subcomponents that, together with the memory 510 and communications component 520, enable the node 110n to operate as a peer with other nodes in a distributed ledger network, such as distributed ledger network 100 described in accordance with FIG. 1. In some embodiments, the consensus module includes a cryptography component 540 that employs aspects of asymmetric cryptography (such as public-private key cryptography) to digitally authenticate transactions sent to the node or digitally sign transactions sent from the node. The consensus module 530 can also include a validating component 550 for determining that a transaction communicated thereto is valid and authentic. A transaction, such as one to redeem STSC tokens, can be validated by determining that the sender of the transaction has sufficient balance of STSC tokens to send the transaction (e.g., redeem the STSC tokens for fiat currency). A transaction, sent from an address of the sender (e.g., a redemption requestor), can also be authenticated by determining that the transaction is digitally signed with a private key associated with the sender's wallet address.

In some embodiments, a consensus module 530 can also include a block generating component 550. The block generating component 560 can group validated transactions into a block of transactions, each of which is cryptographically linked to a previously-generated block of grouped and validated transactions. As the aforementioned processes for block generation are generally known in the art, additional detail for such processes are not described herein. It is contemplated, however, that any implementation of block generation and consensus determination can be employed in accordance with the present disclosure.

In some embodiments, consensus module 530 can include a settlement token dispersing component 570. The settlement token dispersing component 570 can execute functions or operations defined in a STSC generated by a FIS, such as FIS 250 of FIGS. 2 and 4. For a non-limiting example, a STSC associated with a settlement token can include one or more defined fields, such as a token class unique identifier associated with the settlement tokens minted by the STSC, a token creator routing number, a settlement token smart contract incentive (i.e. reward) corresponding to a rate of reward per settlement token held by a requestor, a maturation period, and an approved oracle, among other things. As each node 110n of a distributed ledger network includes common components and maintains a common copy of the distributed ledger, each node can commonly execute the functions or operations defined in the smart contract.

In some embodiments, the settlement token dispersing component 570 can include a settlement token minting controller 571. Generally the settlement token minting controller 571 enables the consensus module 530 to execute operations stored on the distributed ledger in association with a STSC for minting settlement tokens. For example, an initial transaction generated by a PRD, such as PRD 230, a client device 260, or a PNS 240 can be received by node 110n. The initial transaction can include a reference to a STSC, the value of the transaction, a requestor wallet address associated with the payment requestor, and a reference to a corresponding legacy transaction. The settlement token minting controller 571 can identify the conditions defined by the minting function of the STSC corresponding to the referenced STSC in the transaction. For example, the settlement token minting controller 571 can determine that the STSC requires FIS 250 authorization of the transaction (such as a digital signature of the FIS 250), a digital signature of the PNS 240, and a digital signature of the PRD 230, amongst other conditions or any combination thereof. In some embodiments, the settlement token minting controller 571 executes the mint function of the STSC only when all of the minting conditions defined by the STSC are satisfied. In some embodiments, the mint function generates settlement tokens corresponding to the value of the transaction and distributes the settlement tokens to the payment requestor's wallet address.

In some embodiments, the settlement token dispersing component 570 includes a settlement token reward controller 572. Generally the settlement token reward controller 572 enables the consensus module 530 to calculate settlement token rewards based on received transactions and disperses the calculated rewards to the requesting wallet address. For example, where an STSC defines a reward in response to use of the STSC token (such as holding settlement tokens minted by the STSC for a defined period of time) and a reward transaction includes a signed confirmation by an approved oracle confirming the satisfaction of the reward conditions, the settlement token reward controller 572 can modify the locally maintained distributed ledger to add the reward settlement token(s) to the reward requestor's wallet address. As a non-limiting illustration, a first STSC defines a 1% reward for settlement tokens held by a wallet address at least 48 hours after minting subject to oracle verification. When a reward request is received that references the first STSC from a wallet address holding 1,000 settlement tokens minted by the first STSC and the oracle provides verification that the 1,000 settlement tokens were minted at least 48 hours prior to the reward request, the settlement token reward controller 572 can add the reward settlement tokens to the requestor's wallet address (in this case 10 settlement tokens). In some embodiments, the settlement token reward controller 572 can determine the amount of settlement tokens owned by the requesting wallet address that qualify for the reward and those that do not qualify. For example, if in the previous example the oracle confirms that the STSC reward conditions are satisfied for only 100 settlement tokens of the 1,000 settlement tokens owned by the requestor's wallet address; the settlement token reward controller 572 only adds the reward for the 100 settlement tokens (1 settlement token). Further, in some embodiments the settlement token reward controller 572 can trace the transaction history of settlement tokens and determine the elapsed time since a previous reward for the settlement token(s) was given, the elapsed time since the settlement token was minted, or both. Accordingly, by employing the settlement token reward controller 572 the node 110n can determine that a request for settlement token reward is a legitimate reward request, that the set of conditions required for the reward are satisfied and distribute the calculated reward to the requestor's wallet address.

In some embodiments, the settlement token dispersing component 570 can include a settlement token redemption controller 573. Generally the settlement token redemption controller 573 enables the consensus module 530 to execute operations associated with a STSC for redeeming settlement tokens. For example, a redemption transaction generated by a PRD 230, a client device 260, or a PNS 240 can be received by node 110n. The redemption transaction can include a reference to a depository financial institution account, a requestor's wallet address, a value of a specified settlement token, and a request for redemption to a specified fiat currency (such as US dollars). Additionally, the redemption transaction can include a digital signature of the FIS 250 and a digital signature associated with the requestor's wallet address. The settlement token redemption controller 573 can determine that the STSC requires FIS 250 authorization of the transaction (such as a digital signature of the FIS 250), a digital signature of the PNS 240, a digital signature of the PRD 230, amongst other conditions, or any combination thereof. In some embodiments, the settlement token redemption controller 573 executes a redemption function of the STSC only when all of the redemption conditions defined by the STSC are satisfied. In some embodiments, the redemption function transfers settlement tokens corresponding to the value of the transaction from the requestor's wallet address to a wallet address associated with the STSC creator (e.g., the wallet address of the FIS 250).

In some embodiments, the settlement token dispersing component 570 can include a settlement token burning controller 574. Generally the settlement token burning controller 574 enables the consensus module 530 to execute operations associated with a STSC for burning settlement tokens. For example, a burn transaction generated by a PRD a client device 260, a FIS 250, or a PNS 240 can be received by node 110n. The settlement token burning controller 574 can identify the conditions defined by the burn function of the STSC corresponding to the referenced STSC in the transaction. For example, the settlement token burning controller 574 can determine that a STSC requires FIS 250 authorization of the transaction (such as a digital signature of the FIS 250), a digital signature of the requestor (such as the FIS 250, PNS 240, or PRD 230), and a request to burn the settlement tokens, amongst other conditions, or any combination thereof. In some embodiments, the settlement token burning controller 574 executes a burn function of the STSC only when all of the burn conditions defined by the STSC are satisfied. In some embodiments, by executing the burn function the settlement token burning controller 574 eliminates settlement tokens corresponding to the value of the transaction by removing the settlement tokens from the requestor's wallet address without transferring the settlement tokens to another wallet address.

In some embodiments, the consensus module 530 can include a wallet component 580. In some aspects, the wallet component 580 can securely store a private key of a user. Typically, the wallet component 580 is included when a PRD (such as PRD 230) a computing device (such as client device 260), a PNS (such as PNS 240), or a FIS (such as FIS 250) is also operating as a node of the distributed ledger network, such as nodes 110n of FIG. 2. Among other things, the wallet component 580 can parse, from a locally-stored copy of the distributed ledger, one or more transactions associated with a public key associated with the stored private key, so that only those transactions that are addressed from or to the public key are provided for display. The wallet component 580 is generally associated with a GUI that provides the user with a list of relevant transactions. The wallet component 580 can receive inputs from a user to generate transactions, and can sign those transactions with the stored private key. It can also provide the user with updates regarding a transaction status via the GUI. Additionally, in some embodiments, the wallet component 580 can be coupled with a fiat currency account management application or service provided by the client device, PRD 230, PNS 240, or FIS 250. In this regard, the wallet component 580 can further parse the distributed ledger to identify transactions or records that reference fiat currency account identifiers (such as routing and account numbers) associated with fiat accounts on the client device. In this way, the wallet component 580 can be employed to detect when a real-time settlement transaction that mints, rewards, redeems, or burns settlement tokens for an wallet address is executed and available for viewing (i.e., stored on the distributed ledger), to detect when a fiat currency transaction corresponding to a real-time settlement redemption transaction is completed, or any variation thereof in accordance with various embodiments described herein.

Turing to FIG. 6, a block diagram is provided depicting method 600 for converting a legacy settlement transaction to a distributed ledger (e.g., blockchain) settlement transaction in accordance with the present disclosure. Some embodiments of method 600 are implemented by a PNS 240, PRD 230, node 110n, and FIS 250. At block 602, a PNS 240 generates an authorization for FIS 250 participation in distributed ledger settlement transactions. For example, a depository financial institution's FIS 250 is provided a digital participation agreement by a PNS 240. The digital participation agreement can include fiat currency holding and other financial liquidity requirements (such as creditworthiness, asset and liability data, and so forth), a request for the FIS public key, a request for corresponding routing number(s) and IIN number(s), and any other safety and soundness data the PNS 240 deems necessary for participation. A computing device associated with the financial institution can be employed to manually or automatically populate the participation agreement and digitally sign the agreement with a private key(s) corresponding to the disclosed public key(s). The FIS 250 communicates the populated agreement to the PNS 240. In some embodiments, the PNS 240 automatically verifies the digital signature of the participation agreement. Further, the PNS 240 determines that the digital signature corresponds to the public keys included in the participation agreement. In some embodiments, the PNS 240 (or the entity controlling the PNS 240) validates the fiat currency holding requirements and any other requirements included in the agreement. In some embodiments, in response to the validation of the participation agreement, the PNS 240 creates a record in a directory including the FIS public key(s), routing number(s), IIN number(s), FIS identifying data, and other relevant information in a storage component, such as storage component 244. In an embodiment, the PNS 240 communicates an authorization response to the FIS 250.

At block 604, a settlement token smart contract (STSC) is generated. In aspects, the FIS 250 can generate a smart contract using a Turing complete programming language, such as Solidity, by way of non-limiting example. The FIS 250 can generate terms of the smart contract including those discussed above in relation to FIGS. 1 and 4. For an illustrative non-limiting example, the FIS 250 can generate a smart contract that includes functions governing the generation of settlement tokens corresponding to the validation of a distributed ledger transaction referencing the smart contract (e.g., minting settlement tokens); the deduction of a specified value of settlement tokens from an address (e.g., burning settlement tokens); the transfer of settlement tokens predicated on the inclusion of the FIS 250 digital signature in a transaction referencing the smart contract. In an aspect, the FIS 250 signs the smart contract and sends the generated settlement token smart contract to a node, such as node 110n, or a PNS, such as PNS 240.

At block 606, the STSC is communicated to a node, such as node 110n. The STSC can be communicated to the node by the creating FIS 250 or the PNS 240. As described in relation to FIG. 1, the STSC can be added to the registry of the distributed ledger. In an embodiment, the node 110n assigns the settlement token smart contract a transaction number, an address, or any combination thereof. In an aspect, the FIS 250 sends the STSC address, the unique identifier of the smart contract, and any other information associated with the smart contract to the PNS 240 for storage.

In some embodiments, the PNS 240 generates an authorization for PRD 230 participation in distributed ledger settlements, at block 608. In an embodiment, a payment requestor's PRD 230 or other computing device is provided a digital participation agreement by a PNS 240. In an embodiment, a payment requestor's PRD 230 is provided a digital participation agreement by a financial institution's FIS, such as FIS 250. The digital participation agreement can include a request for depository financial institution account information (such as ABA routing and account data), entity registration information (such as, reference to incorporation, or other formal registration information), public key(s) associated with the payment requestor, and any other data deemed relevant by the entity controlling the PNS 240 or FIS 250 (such as data required to perform vetting or due diligence). The digital participation agreement can be automatically or manually populated by the PRD 230 or other computing device associated with the payment requestor. Additionally, in some embodiments, the participation agreement is digitally signed by a key associated with the payment requestor. The completed participation agreement is communicated directly or indirectly (such as through the FIS 250) to the PNS 240 for manual or automatic review. Where the agreement is indirectly communicated to the PNS 240 through a FIS 250, review can occur by the FIS 250 or a computing device associated thereto. In such an embodiment, the FIS 250 can digitally sign the participation agreement before communicating the agreement to the PNS 240. Once received, the information contained in the participation agreement is extracted and stored as a record in storage component 244.

At block 610, the PNS 240 receives a transaction request requiring settlement from a PRD 230. In some aspects, the transaction request can be a legacy settlement received from a PRD 230 associated with a specific payment requestor. For example, the PRD 230 can send a card number and payor authorization (such as a pin, signature, device ID, or any other data indicating the payor's deliberate use of the card or account associated with the card) to a communication component of a PNS, such as PNS 240. The PNS 240 enters the transaction into a legacy settlement component, such as legacy settlement component 242 for storage and batch legacy settlement processing. For example, the PNS 240 parses the data received from the PRD 230 to identify the FIS, such as FIS 250, associated with the financial institution responsible for the card (such as through the IIN or ABA routing number).

At block 612, the PNS 240 receives a request for real-time settlement (RTS). In some aspects, a PRD 230 can communicate the request for RTS of a previously submitted legacy transaction to the PNS 240. For example, the legacy transaction can be the legacy transaction received by the PNS 240 in block 610. The request can trigger the PNS 240 to activate a real-time settlement component, such as real-time settlement component 241. In some embodiments, the request sent by the PRD 230 includes the payment requestor's rules for STSC eligibility. For example, the request from the PRD 230 can limit STSC eligibility by the identity of the STCS creator, requirements for maturation, the value of the transaction, and other business logic parameters.

At block 614, the PNS 240 parses the initial legacy transaction to determine if the initial legacy transaction is eligible for real-time settlement. For example, real-time settlement component 241 queries storage component 244 to determine if the FIS (such as the FIS associated with the payor, the FIS associated with the payment requestor, or both payor and payment requestor FIS) is listed as authorized for participation in distributed ledger settlement transactions. Said another way, the PNS 240 determines whether the FIS is an FIS 250 or a non-participating FIS. In some aspects, where the PNS 240 determines that the initial transaction is not eligible for real-time settlement, the PNS 240 processes the transaction in the legacy payment network, at block 616. In some embodiments, the PNS 240 processes the legacy payment via the legacy settlement component 242 or communication component 243, such as via a central authority.

Returning to block 614, where the PNS 240 determines that the initial transaction is eligible for processing by real-time settlement, the PNS 240 searches the distributed ledger on one or more nodes, such as node 110n, for STSCs stored in the distributed ledger with a key or reference corresponding to a key or reference associated with the FIS 250 of the payor included in the initial legacy transaction. In some embodiments, the PNS 240 eliminates otherwise eligible STSCs that include at least one condition that conflicts with any rules provided by the PRD 230 (for example, in block 612). The PNS 240 communicates a list of eligible STSCs to the PRD 230 for selection. The list can comprise the address of the STSC in the distributed ledger, the STSC information, and any other relevant information for each eligible STSC.

At block 622, a STSC is selected for converting the legacy settlement to a real-time settlement. In an embodiment, the PRD 230 or a client device 260 associated with the PRD 230 can present the list of eligible STSCs for display to a user. Further, the PRD 230 or the computing device can verify the data included in the list by searching the distributed ledger on one or more nodes, such as node 110n. One or more STSCs is selected by the PRD 230 or the client device 260 for real-time settlement. At block 624, an initial real-time settlement transaction is generated. The initial real-time settlement transaction comprises one or more STSCs references, the value of the transaction, a public key associated with the payment requestor, and a reference to the corresponding legacy transaction. The value of the transaction can correspond to the value of the fiat currency in the corresponding legacy transaction. In some embodiments, the PNS 240 generates the initial real-time settlement transaction. For example, the PRD 230 can communicate a reference to the STSC selected at block 622 to the PNS 240. In some embodiments, the PRD 230 generates the initial real-time settlement transaction. In some embodiments, the PNS 240 communicates the initial real-time settlement transaction to a FIS 250 corresponding to the STSC for authorization. In some embodiments, the PNS 240 communicates the initial real-time settlement transaction to a node, such as node 110n.

As noted above, the initial real-time settlement transaction can include one or more STSCs. For the sake of clarity, the examples described herein use one STSC. However, use of multiple STSCs in a real-time settlement transaction is contemplated by the inventors.

At block 626, an FIS 250 authorizes the initial transaction governed by the rules of the STSC. The FIS 250 corresponding to the STSC can detect the initial real-time settlement transaction in the distributed ledger or receive it from the PNS 240. Generally, the authorization is a digital signature associated with the entity controlling the FIS 250. For example, the initial real-time settlement transaction can be parsed by the FIS 250 to determine the STSC involved, the public key of the payment requestor, and the value of the transaction. The FIS 250 can request the corresponding legacy settlement data from the PNS 240 to verify the value, the key associated with the payment requestor, and any other data deemed relevant to authorization by the FIS 250.

In some embodiments, the FIS 250 compares the legacy settlement data to the initial real-time transaction data. Additionally, the FIS 250 can compare the initial real-time transaction data to the conditions for the STSC stored in the distributed ledger. When the FIS 250 determines that the initial real-time transaction is valid, the FIS 250 digitally signs the initial real-time transaction, thereby providing a FIS authorization for the initial real-time transaction. In some aspects, the use of the digital signature can further prevent down-stream manipulation of the initial real-time transaction, as the digital signature can be generated so that it is valid only when the signed contents are unmodified. Once signed, the FIS 250 communicates the digitally signed initial transaction to a PNS, such as PNS 240.

At block 630, the PNS 240 removes the legacy transaction corresponding to the signed initial transaction from the legacy payment network. For a non-limiting example, the real-time settlement component 241 can parse the digitally signed initial real-time transaction, verify the digital signature as corresponding to the FIS 250 associated with the STSC, and determine the legacy transaction corresponds to the real-time transaction. In some embodiments, the real-time settlement component 241 places a digital hold on the legacy settlement transaction, thereby preventing legacy settlement processing until the hold is removed. In some embodiments, the real-time settlement component removes the legacy settlement transaction from a legacy processing queue used by legacy settlement component 242 or storage component 244, thereby preventing legacy settlement processing until the legacy settlement transaction is resubmitted to the legacy processing queue. In some embodiments, the real-time settlement component 241 can modify the legacy settlement transaction in legacy settlement component 242 or storage component 244 so that it is not included in the legacy processing queue. The legacy processing queue can include a pool of a plurality of legacy settlement transactions that are processed in a batch or individually. In some aspects, the PNS 240 digitally signs the initial real-time settlement transaction previously signed by the FIS 250. In some aspects, the PNS 240 communicates the signed (by the FIS 250, or both the FIS 250 and PNS 240) initial real-time settlement transaction to the PRD 230 or client device 260 associated with the PRD 230.

At block 632, the PRD 230 or a computing device associated with the PRD, such as client device 260, generates an authorized transaction. In some aspects, the PRD 230 or a computing device associated with the PRD 230 receives the signed initial real-time settlement transaction from the PNS 240. The PRD 230, or a computing device associated with the PRD 230, can parse the signed initial real-time settlement transaction to verify that the included data matches the digital signature of the PNS 240, FIS 250, or both the PNS 240 and FIS 250. Additionally, the PRD 230 or client device 260 associated with the PRD 230 can verify that the signed initial real-time settlement transaction matches the (unsigned) initial real-time settlement transaction submitted for authorization by the FIS 250. The PRD 230 or client device 260 associated with the PRD 230 generates an authorized transaction comprising the signed initial real-time settlement transaction, the address of the STSC, and a digital signature generated by a key associated with the entity controlling the PRD 230.

At block 634, the authorized transaction is communicated to a node of the distributed network and the referenced STSC mints settlement tokens corresponding to the value of the transaction. For a non-limiting example, a PRD 230 or client device 260 associated with the PRD 230 communicates a transaction generated at block 632 to a node, such as node 110n. The node generates an entry in the local copy of the distributed ledger referencing the STSC. The node can then verify that the conditions for executing the mint function of the STSC are met. For example, that the transaction includes the digital signature corresponding to the creator's FIS 250, the payment requestor's digital signature, and any other conditions included in the STSC's code. When the conditions are met, the node can execute the mint function and generate settlement tokens corresponding to the conditions of the STSC in an amount corresponding to the value of the transaction. The generated settlement tokens comprise data associated with the token's mint date, the STSC corresponding to the settlement token, and any other data specified by the STSC mint function. At block 636, the minted settlement token is sent to the wallet address associated with the PRD 230. In some aspects, the minted settlement tokens are “sent” to the wallet address associated with the PRD 230 by creating an entry in the distributed ledger (e.g., blockchain) crediting the wallet address with the settlement tokens. This transaction can be distributed throughout the plurality of nodes, verified, and validated as described above. In some embodiments, at block 636, the PNS 240 can detect a block of validated transactions including the transaction referencing the STSC in the distributed ledger of a node. In response, a real-time settlement component, such as real-time settlement component 241 of a PNS, such as PNS 240, removes the legacy settlement corresponding to the real-time settlement transaction from legacy processing. As described in relation to block 630, in some embodiments, a hold can be placed on the legacy settlement, and the PNS 240 can now remove the legacy settlement from the legacy processing queue. Also, as similarly described in relation to block 630, in some embodiments, the legacy settlement can be pulled out of the queue by a real-time settlement component. The real-time settlement component can store the legacy settlement in an archive (not depicted) referencing the corresponding real-time settlement transaction or the legacy settlement can be digitally erased.

At blocks 638 and 639, the settlement tokens can be used in distributed ledger transactions. For an illustrative example, a key associated with the PRD 230 (or the entity controlling the PRD 230) can be used to generate distributed ledger transactions including an amount of settlement tokens. For instance, a transaction can be generated and signed by a private key transferring a set of the settlement tokens generated by one or more STSCs. There can be one, more than one, or a plurality of transactions generated transferring one or more settlement tokens between addresses associated with key(s) (private or public) credited with possession of the one or more settlement tokens. As this will be understood by those skilled in the art, the details of this process are not described herein.

At block 640, the settlement tokens is be submitted for redemption to fiat currency. Generally, block 640 comprises a conversion of a specified settlement token from an address on the distributed ledger to fiat currency in a fiat account associated with the redeeming entity at a depository financial institution by a FIS such as FIS 250. As the settlement tokens are transferable, it is contemplated that the redeeming entity (redemption requestor) can include any person, business, group, institution, or any combination thereof that controls an address (unique redeemer identifier) with settlement tokens. This includes but is not limited to, the original payor, the payment requestor, the entity controlling the PNS 240, the entity controlling the FIS 250, any other financial institution, an entity controlling one or more client devices, and an entity controlling one or more nodes. However, for the sake of clarity, the illustrative examples provided herein generally treat the payment requestor as the redemption requestor.

For a non-limiting example, a transaction can be generated by a PRD, such as PRD 230, or a computing device associated with the PRD 230 (such as some embodiments of client device 260). For the sake of clarity, the examples provided below are premised on a PRD generating the redemption transaction. However, it is contemplated by the inventors that the redemption transaction can be generated by any computing device capable of communicating with at least one node of a network of nodes, a PNS 240, or an FIS 250. The transaction can include a reference to a fiat account, a distributed ledger address (such as a wallet address), a settlement token amount, and a request for redemption to a specified fiat currency (such as US dollars). The PRD 230 can communicate the redemption transaction to a PNS, such as PNS 240. The PNS 240 parses the transaction to determine a FIS 250 associated with the STSC corresponding to the settlement token specified in the redemption transaction. A real-time settlement component, such as real-time settlement component 241, can search the distributed ledger for the identity of a FIS 250 associated with the STSC. Additionally, or alternatively, in some embodiments, the real-time settlement component 241 queries a directory database stored in storage component 244, which includes unique financial institution identifiers (such as IINs and ABA routing numbers), STSC addresses associated with the unique financial institution identifiers, and settlement token data corresponding to each STSC. Additionally, the PNS 240 can determine the settlement token's eligibility for fiat currency redemption. For a non-limiting example and as described above, the STSC can have specified a required maturation period before settlement tokens generated by (minted by) the STSC can be redeemed for fiat currency. The PNS 240 can verify that the maturation period has elapsed for the settlement tokens specified by the redemption transaction.

In some embodiments, the PNS 240 can communicate the redemption transaction to a FIS, such as FIS 250, corresponding to the STSC. The FIS 250 can initiate automatic, partially automatic, or manual fraud detection, foreign asset control clearance (such as those mandated by the U.S. Treasury's Office of Foreign Asset Control's Sanctions Program Listings as of 2018), anti-money laundering verification of the depository financial institution account referenced in the redemption transaction, and any other regulatory and institutional clearances required by the FIS 250. Once the redemption transaction is approved by the entity controlling the FIS 250, the FIS 250 generates an authorized redemption transaction. The authorized redemption transaction can include, among other data, the settlement token amount, the reference to the fiat account, the wallet address containing the settlement tokens to be redeemed, a digital signature associated with the FIS 250. The FIS 250 can communicate the authorized redemption transaction to a PNS, such as PNS 240.

In some embodiments, a real-time settlement component of a PNS 240 parses the authorized redemption transaction to identify a computing device, such as a PRD 230, a computing device associated with the PRD 230, or any other computing device corresponding to the depository financial institution account or wallet address containing the settlement tokens to be redeemed. Once identified, the PNS 240 can communicate the authorized redemption transaction to the PRD 230 for review. The PRD 230 or client device 260 associated with the PRD 230 can automatically perform the review or can facilitate manual review by displaying the information to an approved user of the PRD 230 via a GUI. The authorized redemption transaction can be digitally signed with a key associated with the entity controlling the PRD 230 and communicated to a PNS, such as PNS 240. In some embodiments the PRD 230 communicates the digitally signed and authorized redemption to a node, such as node 110n. The PNS 240 receives (or detects) the signed and authorized redemption transaction from the PRD 230 (or node 110n). In some embodiments, the real-time settlement component 241 activates a legacy settlement component 242 to create a legacy settlement transaction corresponding to the signed and authorized redemption. Additionally, or alternatively, the real-time settlement component can communicate the signed and authorized redemption transaction to a FIS associated with the financial entity authorizing the redemption, such as FIS 250.

In some aspects, a FIS, such as FIS 250, receives the signed and authorized redemption transaction and parses the data to verify that the signed and authorized redemption transaction matches the corresponding authorized redemption. Where a match is found, the FIS 250 generates a complete redemption transaction to a node, such as node 110n, for entry into a distributed ledger. The complete redemption transaction can include the digital signature corresponding to the address with control of the settlement tokens that are being redeemed (such as the digital signature provided by the PRD 230 in the example signed and authorized redemption transaction discussed above), an address associated with the entity controlling the FIS 250, and the settlement token amount. A node, such as node 110n, can receive the complete redemption transaction and enter a corresponding transaction to the local copy of the distributed ledger. As a result the settlement tokens amount can be removed from the address corresponding to the party that requested redemption and added to the address corresponding to the entity controlling the FIS 250.

Additionally, or alternatively, the FIS 250 can include instructions in the complete redemption transaction that activate the STSC's burn function. In such a case, the node 110n can execute the STSC burn function. The node 110n can remove the appropriate amount of settlement tokens from the address of the party that requested redemption without adding them to another account. Said another way, the redemption transaction can include a digitally signed instruction to remove the specified amount of settlement tokens from circulation via the STSC's burn function. This transaction can be distributed throughout the plurality of nodes, verified, and validated as described above.

In some embodiments, the PNS 240 or FIS 250 can detect a block of validated transactions including the complete redemption transaction. In some aspects, in response to detecting the block, the FIS 250 can communicate to the PNS 240 an authorization to release the legacy settlement transaction corresponding to the redemption transaction. In response to detecting the block or to the authorization received from the FIS 250, the real-time settlement component 241 can activate the legacy settlement component to enter the legacy settlement transaction transferring fiat currency to the account specified in the signed and authorized redemption transaction for processing by a legacy settlement network. The legacy settlement comprises instructions to the legacy settlement network for the transfer of fiat currency from, for illustrative example, a first FIS 250 to a second FIS 250. In some aspects, the amount of the fiat currency is equal to the amount of the settlement tokens in the corresponding settlement token redemption transaction. In some aspects, in response to detecting the block, the FIS 250 can communicate to the PNS 240 an authorization to release the legacy settlement transaction corresponding to the redemption transaction.

Alternatively, in some embodiments, a redemption controller of the FIS 250, such as redemption controller 253 can detect a signed and authorized redemption transaction in a distributed ledger. The FIS 250 can parse the transaction to identify an account and credit or debit an amount of fiat currency in a fiat account corresponding to the real-time settlement transaction. For example, the FIS 250 can debit an amount of fiat currency from a holding account associated with the entity controlling the FIS 250 and credit the corresponding amount of fiat currency to the redemption requestor's account referenced (or identified) in the signed and authorized redemption transaction.

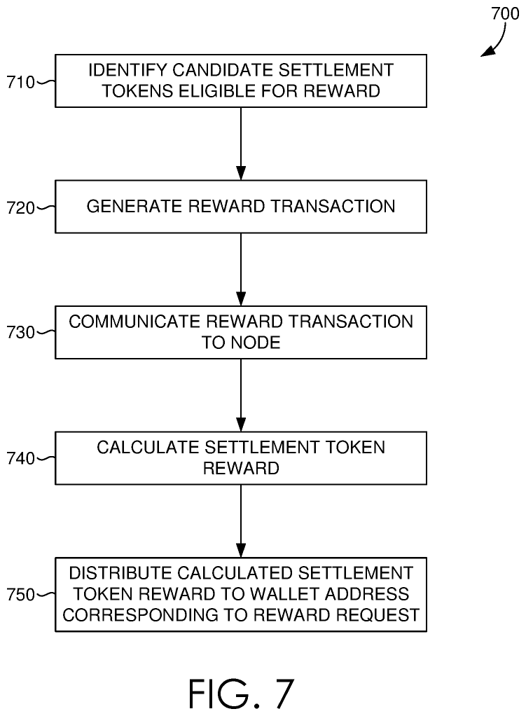

With reference to FIG. 7, a block diagram is provided depicting method 700 for distributing a settlement token reward in accordance with the present disclosure. Some embodiments of method 700 can be implemented by components of system 200 of FIG. 2.

At block 710, candidate settlement tokens eligible for reward are identified. In some embodiments, the PRD 230 (or client device 260) can identify settlement tokens held by the user on the distributed ledger by communicating with a node 110n. For a non-limiting example, a GUI associated with PRD 230 (or client device 260) can provide a user a list of settlement token classes and the corresponding amount of settlement tokens currently held by the user's address(es) according to a wallet component of node 110. Additionally, the PRD 230 (or client device 260) can search the distributed ledger to determine whether the settlement tokens of a token class is eligible for a reward. For a non-limiting example, the PRD 230 (or client device 260) can identify reward conditions of settlement tokens minted by the STSC associated with the settlement token class. Based on the record of transactions (such as the minting transaction or previous reward transaction) in the distributed ledger and the STSC the PRD 230 (or client device 260) can determine whether the settlement tokens held by the wallet address(es) controlled by the PRD 230 (or client device 260) are eligible for a reward. For a non-limiting example, a STSC can define that a settlement token reward of 0.33% accrues per settlement token, per 24 hours after settlement token minting until the first settlement token redemption. The PRD 230 (or client device 260) can track the transaction history of each settlement token currently held by the wallet address. For a non-limiting example, the PRD 230 (or client device 260) determines that 1,000 settlement tokens of the 10,000 settlement tokens held by wallet address associated with the PRD 230 (or client device 260) have 1) not been redeemed, 2) were minted 48 hours ago, and 3) the last reward was distributed 24 hours ago. The PRD 230 (or client device 260) also determines that the other 9,000 settlement tokens are not eligible for reward because, for example, 6,000 haven been redeemed and redistributed and 3,000 were minted less than 24 hours ago. Accordingly, in some embodiments, the GUI of PRD 230 (or client device 260) displays that 10,000 settlement tokens are held but only 1,000 settlement tokens are eligible for a reward. Further, the GUI can display the potential reward of 3.3 settlement tokens for the 1,000 eligible settlement tokens. It will be understood by those skilled in the art that the period, rate, and other conditions in the above example are merely illustrative and not intended to limit the scope of the embodiments described herein.

At block 720 the PRD 230, a computing device (such as client device 260), a PNS 240, a FIS 250, or any other computing device generates a reward transaction. The reward transaction can comprise a reward request, the reward requestor's wallet address, a digital signature associated with the reward requestor's wallet address, and a reference to an STSC that minted the settlement tokens. In some embodiments, the GUI of PRD 230 (or client device 260) can provide an interactive command (such as a menu option) to generate the reward transaction. Continuing with the example from block 710, a user can select a menu option to redeem the 1,000 eligible settlement tokens. In response, the PRD 230 (or client device 260) can generate a reward transaction including a reference to the STSC that minted the settlement tokens, the user's (requestor's) wallet address, a reward request, and a digital signature associated with the wallet address. The generated reward transaction can be communicated to a node, such as node 110n, maintaining a local copy of the distributed ledger at block 730. Upon receiving the reward transaction, the node 110n can parse the reward transaction and identify the STSC corresponding to the reference included in the reward transaction. Further, the node 110n can verify that the digital signature is valid for the wallet address. In some embodiments, the STSC can identify one or more oracles that are approved to provide data to the node 110n to complete the reward transaction. The node 110n can request, access, or receive data from the oracle, such as the date and time of the last reward. For example, in some embodiments an oracle determines the date and time of the last reward for the settlement tokens attributed to the wallet address included in the reward transaction and communicates the date and time to the node. In some embodiments, the node 110n can be a designated oracle and determine the date and time of the last reward.

At block 740, the settlement token reward is calculated by a node, such as node 110n. For example, the node 110n can determine how many settlement tokens are held by the wallet address in the reward transaction and of those how many qualify for the reward defined by the STSC. Returning to the illustrative example, the node 110n can detect that the wallet address associated with the reward request holds 10,000 total settlement tokens minted by the STSC. Further, utilizing the algorithms of the smart contract (and in some embodiments, data provided by an oracle) the node 110n can determine that only 1,000 of the settlement tokens qualify for a reward. The node 110n calculates that for the 1,000 settlement tokens a reward of 3.3 settlement tokens is defined by the STSC (1,000×0.33%=3.3). As will be understood by those skilled in the art, the rewards defined by the STSC can customized by the financial institution controlling the FIS 250 that created the STSC. For another illustrative example, the reward can be based on the average daily balance of settlement tokens held by the wallet address prior to the last reward.

At block 750, the reward settlement tokens are distributed to the wallet address included in the reward transaction by the node, such as node 110n. For example, the node 110n can credit (add) the calculated reward of settlement tokens to the wallet address in the reward request. In the previous example, 3.3 settlement tokens can be credited to the wallet address.

With reference to FIG. 8, computing device 800 includes a bus 810 that directly or indirectly couples the following devices: memory 812, one or more processors 814, one or more presentation components 816, input/output (I/O) ports 818, input/output (I/O) components 820, an illustrative power supply 822, and a radio 824. Bus 810 represents what can be one or more busses (such as an address bus, data bus, or combination thereof). Although the various blocks of FIG. 8 are shown with lines for the sake of clarity, in reality, delineating various components is not so clear, and metaphorically, the lines would more accurately be grey and fuzzy. For example, one can consider a presentation component such as a display device to be an I/O component. Also, processors have memory. The inventors recognize that such is the nature of the art, and reiterate that the diagram of FIG. 8 is merely illustrative of an exemplary computing device that can be used in connection with one or more embodiments of the present invention. Distinction is not made between such categories as “workstation”, “server”, “laptop”, “handheld device”, etc., as all are contemplated within the scope of FIG. 8 and reference to “computing device”.

Computing device 800 typically includes a variety of computer-readable media. Computer-readable media can be any available media that can be accessed by computing device 800 and includes both volatile and nonvolatile media, removable and non-removable media. By way of example, and not limitation, computer-readable media can comprise computer storage media and communication media. Computer storage media includes both volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computing device 800. Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared, and other wireless media. Combinations of any of the above should also be included within the scope of computer-readable media.

Memory 812 includes computer-storage media in the form of volatile and nonvolatile memory. The memory can be removable, non-removable, or a combination thereof. Exemplary hardware devices include solid-state memory, hard drives, optical-disc drives, etc. Computing device 800 includes one or more processors that read data from various entities such as memory 812 or I/O components 820. Presentation component(s) 816 present data indications to a user or other device. Exemplary presentation components include a display device, speaker, printing component, vibrating component, etc.

I/O ports 818 allow computing device 800 to be logically coupled to other devices including I/O components 820, some of which can be built in. Illustrative components include a microphone, joystick, game pad, satellite dish, scanner, printer, wireless device, etc.

Many different arrangements of the various components depicted, as well as components not shown, are possible without departing from the scope of the claims below. Embodiments of our technology have been described with the intent to be illustrative rather than restrictive. Alternative embodiments will become apparent to readers of this disclosure after and because of reading it. Alternative means of implementing the aforementioned can be completed without departing from the scope of the claims below. Certain features and subcombinations are of utility and can be employed without reference to other features and subcombinations and are contemplated within the scope of the claims.

The invention claimed is:

1. A non-transitory computer storage medium storing computer-useable instructions that, when used by one or more computing devices, cause the one or more computing devices to perform operations comprising:
receiving, by a server, a first swap request from a remote computing device associated with a requestor, the received first swap request including a requestor identifier associated with the requestor, a first payment amount, and an address to a smart contract associated with a financial entity and stored on a distributed ledger, wherein the received first swap request corresponds to a received first legacy transaction included in a processing queue;
transmitting, by the server, the received first swap request to a remote server associated with the financial entity, wherein the remote server is configured to digitally sign the transmitted first swap request;
communicating, by the server, the digitally-signed swap request to the remote computing device based on a receipt thereof from the remote server, wherein the communication enables the remote computing device to generate, for storage on the distributed ledger, a first transaction based on the digitally-signed swap request;
removing, by the server, the first legacy transaction from the processing queue based on a determination that the distributed ledger includes the first transaction associated with the stored smart contract and generated based on the digitally-signed swap request, the generated first transaction providing a first token value corresponding to the first payment amount to the requestor identifier.

2. The non-transitory computer storage medium of claim 1, wherein the generated first transaction includes the digitally-signed swap request.

3. The non-transitory computer storage medium of claim 1, wherein the processing queue includes a pool of legacy transactions pending batch finalization.

4. The non-transitory computer storage medium of claim 1, further comprising:
determining, by the server, that the distributed ledger includes a second transaction comprising the requestor identifier, a second token value, and the smart contract address, the second transaction disassociating the second token value from the requestor identifier and associating the second token value to a redemption identifier referenced by the smart contract; and
transmitting, by the server, instructions to the remote server to deposit fiat currency corresponding to the second token value in an account associated with the requestor.

5. The non-transitory computer storage medium of claim 4, further comprising:
receiving, by the server, an indication from the remote server that a second payment amount of a fiat currency was deposited in an account corresponding to the requestor identifier, the second payment amount corresponding to the second token value.

6. The non-transitory computer storage medium of claim 4, wherein the remote server is associated with the financial entity.

7. A system comprising:
a payment-network server for:
receiving, from a first computing device associated with a payment requestor, a first transaction request comprising a payor identifier, a requestor identifier associated with the payment requestor, a payment amount, and a smart contract address,
wherein the smart contract address corresponds to a smart contract stored in a distributed ledger and when executed by a node is configured to generate a token value that corresponds to the payment amount in response to a determination that the distributed ledger includes the first transaction request digitally signed with keys associated with the payment requestor and a financial entity of the payor, wherein the smart contract is associated with the financial entity, and wherein the first transaction request corresponds to a legacy transaction request stored by the payment-network server; and
removing the legacy transaction from a legacy processing queue based on a confirmation to replace the legacy transaction request with the first transaction request, wherein the confirmation is received from a second computing device associated with the financial entity and comprises a transaction digitally signed by a key associated with the financial entity.

8. The system of claim 7, wherein the first transaction is digitally signed by the key associated with the financial entity comprises the requestor identifier associated with the payment requestor, the payment amount, and the smart contract address.

9. The system of claim 8, wherein the first transaction is digitally signed by the key associated with the financial entity further comprises the payor identifier.

10. The system of claim 7, wherein the distributed ledger is a blockchain maintained by a plurality of distributed nodes.

11. The system of claim 7, wherein the payment-network server is further for:
receiving, by the payment-network server and from a third computing device associated with a redemption requestor, a second transaction request comprising a redeemer identifier, a second payment amount, and the smart contract address, wherein the smart contract address corresponds to the smart contract stored in a distributed ledger and configured to remove the token value based on the second payment amount in response to a determination that the distributed ledger includes the second transaction request digitally signed with keys associated with the redeemer and the financial entity; and
generating a second legacy transaction for storage by the payment-network server storage based on a confirmation to replace the second transaction request with the second legacy transaction request, wherein the confirmation is received from the second computing device associated with the financial entity.

12. The system of claim 11, wherein the payment-network server is further for:
receiving, by the payment-network server and from a financial institution server, an indication that a first value of a fiat currency was deposited in an account corresponding to an entity associated with the redeemer identifier, the first value corresponding to the second payment amount.

13. The system of claim 7, further comprising:
a financial institution server for:
generating the smart contract, wherein the smart contract is stored in the distributed ledger.

14. The system of claim 7, further comprising:
a payment requestor device for:
generating a legacy transaction comprising the payor identifier, the requestor identifier, and the payment amount, wherein the legacy transaction is communicated to the payment-network server.

15. A computer-implemented method comprising:
receiving, by a server, a first swap request from a remote computing device associated with a requestor, the received swap request including a requestor identifier associated with a requestor, a first payment amount, and an address to a smart contract associated with a financial entity and stored on a distributed ledger, wherein the first swap request corresponds to a received first legacy transaction included in a processing queue;
transmitting, by the server, the received first swap request to a remote server associated with the financial entity, wherein the remote server is configured to digitally sign the transmitted first swap request;
communicating, to the remote computing device, the digitally-signed swap request received from the remote server, wherein the communication enables the remote computing device to generate a first transaction based on the digitally-signed swap request for storage on the distributed ledger;
removing, by the server, the first legacy transaction from the processing queue based on a determination that the distributed ledger includes the first transaction associated with the stored smart contract and generated based on the digitally-signed swap request, the first transaction providing a first token value corresponding to the first payment amount to the requestor identifier.

16. The computer-implemented method of claim 15, wherein the generated transaction includes the digitally-signed swap request.

17. The computer-implemented method of claim 16, wherein the distributed ledger is a blockchain maintained by a plurality of distributed nodes.

18. The computer-implemented method of claim 15, further comprising:
determining, by the server, that the distributed ledger includes a second transaction comprising the requestor identifier, a second token value, and the smart contract address, the second transaction disassociating the second token value from the requestor identifier and associating the second token value to a redemption identifier referenced by the smart contract; and
transmitting, by the server, instructions to the remote server to deposit fiat currency corresponding to the second token value in an account associated with the requestor.

19. The computer-implemented method of claim 15, further comprising:
receiving, by the payment-network server and from a third computing device associated with a redemption requestor, a second transaction request comprising a redeemer identifier, a second payment amount, and the smart contract address, wherein the smart contract address corresponds to the smart contract stored in a distributed ledger and configured to remove the token value based on the second payment amount in response to a determination that the distributed ledger includes the second transaction request digitally signed with keys associated with the redeemer and the financial entity; and
generating a second legacy transaction for storage by the payment-network server storage based on a confirmation to replace the second transaction request with the second legacy transaction request, wherein the confirmation is received from the second computing device associated with the financial entity.

20. The computer-implemented method of claim 19, further comprising:
receiving, by the payment-network server and from a financial institution server, an indication that a first value of a fiat currency was deposited in an account corresponding to an entity associated with the redeemer identifier, the first value corresponding to the second payment amount.
